(19) United States
(12) Patent Application Publication
(10) Pub. No.: US 2023/0315991 A1
(43) Pub. Date: Oct. 5, 2023

(54) TEXT CLASSIFICATION BASED DEVICE PROFILING

(71) Applicant: FORESCOUT TECHNOLOGIES, INC., San Jose, CA (US)

(72) Inventors: Yi Zhang, Santa Clara, CA (US); Xiaoming Zhou, Sunnyvale, CA (US); Zhiruo Cao, San Jose, CA (US)

(21) Appl. No.: 18/092,150

(22) Filed: Dec. 30, 2022

Related U.S. Application Data
(60) Provisional application No. 63/326,420, filed on Apr. 1, 2022.

(51) Int. Cl. G06F 40/295; G06V 30/19

(52) U.S. Cl. CPC G06F 40/295; G06V 30/19173

(57) ABSTRACT

Systems and methods for generating an entity classification model using text classification of raw text information of entities are described. Generating the classification model includes obtaining raw text information associated with a plurality of entities, converting the raw text information for each entity of the plurality of entities into one or more character strings, generating a numerical vector for each entity of the plurality of entities based on the one or more character strings for each entity, and selecting, based on the numerical vectors for each entity of the plurality of entities, one or more entity properties to be used for entity classification. A classification of a first entity coupled to a network is performed based on the one or more selected entity properties.

### RELATED APPLICATIONS

This application claims priority from and the benefit of U.S. Provisional Patent Application No. 63/326,420 filed on Apr. 1, 2022, the entire contents of which are incorporated herein by reference in its entirety.

### TECHNICAL FIELD

Aspects and implementations of the present disclosure relate to network monitoring, and more specifically, entity profiling using text classification for model generation.

### BACKGROUND

As technology advances, the number and variety of devices or entities that are connected to communications networks are rapidly increasing. Each device or entity may have its own respective vulnerabilities which may leave the network open to compromise or other risks. Preventing the spreading of an infection of a device or entity, or an attack through a network can be important for securing a communication network.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative communication network in accordance with one implementation of the present disclosure.

FIG. 2 depicts an illustrative network topology in accordance with one implementation of the present disclosure.

FIG. 3 depicts an example of a system for generating an entity classification model using text classification, according to some embodiments of the present disclosure

FIG. 4 depicts an example system for performing an entity classification using a classification model generated from raw text information of devices, according to embodiments of the present disclosure.

FIG. 5 depicts a flow diagram illustrating an example method of generating an entity classification model using text classification, in accordance with one implementation of the present disclosure.

FIG. 6 depicts a flow diagram illustrating another example method of generating an entity classification model using text classification, in accordance with one implementation of the present disclosure.

FIG. 7 depicts a flow diagram illustrating an example method of performing entity classification by an entity classification model generated using text classification, in accordance with one implementation of the present disclosure.

FIG. 8 depicts a component diagram for generating an entity classification model using text classification, according to embodiments of the present disclosure.

FIG. 9 is a block diagram illustrating an example computer system, in accordance with one implementation of the present disclosure.

### DETAILED DESCRIPTION

Aspects and implementations of the present disclosure are directed generating an entity classification model using text classification of raw text information associated with network connected entities. The systems and methods disclosed can be employed with respect to network security, among other fields. More particularly, it can be appreciated that devices or entities with vulnerabilities are a significant and growing problem. At the same time, the proliferation of network-connected devices (e.g., internet of things (IoT) devices such as televisions, security cameras (IP cameras), wearable devices, medical devices, etc.) can make it difficult to effectively ensure that network security is maintained.

Conventional device classification is achieved by manually developed fingerprints written by security researchers based on domain expertise of the security researchers. Moreover, these manually developed fingerprints are designed to function (e.g., identify or classify a device) only if all the required properties for a fingerprint are resolved (e.g., properties of an entity match each property defined by the fingerprint). Accordingly, conventional fingerprinting methodologies fail to generate a classification when properties are only partially resolved. Additionally, conventional fingerprinting techniques are unable to deliver fuzzy classifications (e.g., classifications with moderate certainty of accuracy). With the explosive growth in the type of network connected devices (e.g., internet of things (IOT), industrial internet of things (HOT) systems, medical devices, etc.) it becomes important to provide such fingerprints in an accurate and scalable ways. Conventional fingerprinting techniques fail to provide the robustness and scalability necessary for device fingerprinting given the growing number of network connected devices.

Embodiments of the present disclosure apply natural language processing to raw device properties data collected and aggregated from monitored network devices. The raw device properties data may be collected via passive monitoring of network traffic or via active scans of devices of a network. In some embodiments, a text-based model generator obtains the raw device properties data and generates text strings that correspond to different device properties. For example, the raw device properties data for a particular property of a device can be appended together as a single character string. The character strings for the different properties of a device can be included together in a “paragraph” of character strings. In some embodiments, the text-based model generator then applies natural language processing, such as text classification, to the paragraph of character strings of each device. The result of the natural language processing may be to generate a numerical multi-dimensional vector (also referred to as embedding) for each device. Devices with similar vectors indicate similarity of functionality and thus similarity of device type. Accordingly, the result of the natural language processing of the paragraphs of character strings may include groupings of device types.

In some embodiments, the text-based model generator may then determine the device properties that are associated with the grouping of the vectors. For example, a subset of device properties may correlate more strongly with the groupings of devices and the text-based model generator may select those properties to be used for building a classification model. The text-based model generator may then build a classification model (e.g., a machine learning model) using the selected entity properties. In some examples, the text-based model generator selects a subset of the most important properties for classification of each device type grouping and generates a model based on those subsets of device properties. In some embodiments, the text-based model generator trains the classification model using known device classifications and the corresponding properties of those types (e.g., labeled data). For example, the text-based model generator may train the classification model on previously classified devices and the properties of those devices that correspond to the subset or subsets of properties selected based on the text classification. In some embodiments, the text-based model generator trains the classification model using unlabeled data, such as information extracted for entities from the raw device properties data. It should be noted that the terms entity properties, entity features, and entity attributes are used interchangeably herein and refer to discrete identifiable or detectable information associated with an entity.

In some embodiments, the classification model may be a logistic regression, random forest classification, or any other machine learning classifier which takes entity properties as input to provide classification of the entity. In some embodiments, the output of the classification model is a probability vector indicating how likely a device to be classified belongs to various profiles. For example, the classification may output a vector as (0.1, 0.1, 0.2, 0.6, 0) which may indicate that the device being profiled has a probability of 10% to be computer or server, 20% probability to be a mobile device or entity, 60% probability to be a printer, and 0% probability to be a camera. Note these are example device types and the output vector may indicate probabilities of any entity types. Embodiments may use the output result (e.g., output vector) to select and output a single classification result. From the previous example, the classification model may output the classification as “printer” because “printer” is associated with the highest probability in the output vector. Alternatively, the classification result may be used directly as a fuzzy result in future applications (e.g., presenting a recommendation or an indication to user of possible classification).

Embodiments described herein provide advantages over conventional entity profiling and fingerprinting techniques, including increased scalability, automated model generation and updating, robustness with insufficient property resolution, and fuzzy classification with automatic conflict resolve.

It can be appreciated that the described technologies are directed to and address specific technical challenges and longstanding deficiencies in multiple technical areas, including but not limited to network security, monitoring, and policy enforcement. It can be further appreciated that the described technologies provide specific, technical solutions to the referenced technical challenges and unmet needs in the referenced technical fields.

Network segmentation can be used to enforce security policies on a network, for instance in large and medium organizations, by restricting portions or areas of a network which an entity can access or communicate with. Segmentation or “zoning” can provide effective controls to limit movement across the network (e.g., by a hacker or malicious software). Enforcement points including firewalls, routers, switches, cloud infrastructure, other network devices/entities, etc., may be used to enforce segmentation on a network (and different address subnets may be used for each segment). Enforcement points may enforce segmentation by filtering or dropping packets according to the network segmentation policies/rules. The viability of a network segmentation project depends on the quality of visibility the organization has into its entities and the amount of work or labor involved in configuring network entities.

Although some embodiments are described herein with reference to network devices, embodiments also apply to any entity communicatively coupled to the network. An entity or entities, as discussed herein, include devices (e.g., computer systems, for instance laptops, desktops, servers, mobile devices, IoT devices, OT devices, etc.), endpoints, virtual machines, services, serverless services (e.g., cloud-based services), containers (e.g., user-space instances that work with an operating system featuring a kernel that allows the existence of multiple isolated user-space instances), cloud-based storage, accounts, and users. Depending on the entity, an entity may have an IP address (e.g., a device) or may be without an IP address (e.g., a serverless service).

The enforcement points may be one or more network entities (e.g., firewalls, routers, switches, virtual switch, hypervisor, SDN controller, virtual firewall, etc.) that are able to enforce access or other rules, ACLs, or the like to control (e.g., allow or deny) communication and network traffic (e.g., including dropping packets) between the entity and one or more other entities communicatively coupled to a network. Access rules may control whether an entity can communicate with other entities in a variety of ways including, but not limited to, blocking communications (e.g., dropping packets sent to one or more particular entities), allowing communication between particular entities (e.g., a desktop and a printer), allowing communication on particular ports, etc. It is appreciated that an enforcement point may be any entity that is capable of filtering, controlling, restricting, or the like communication or access on a network.

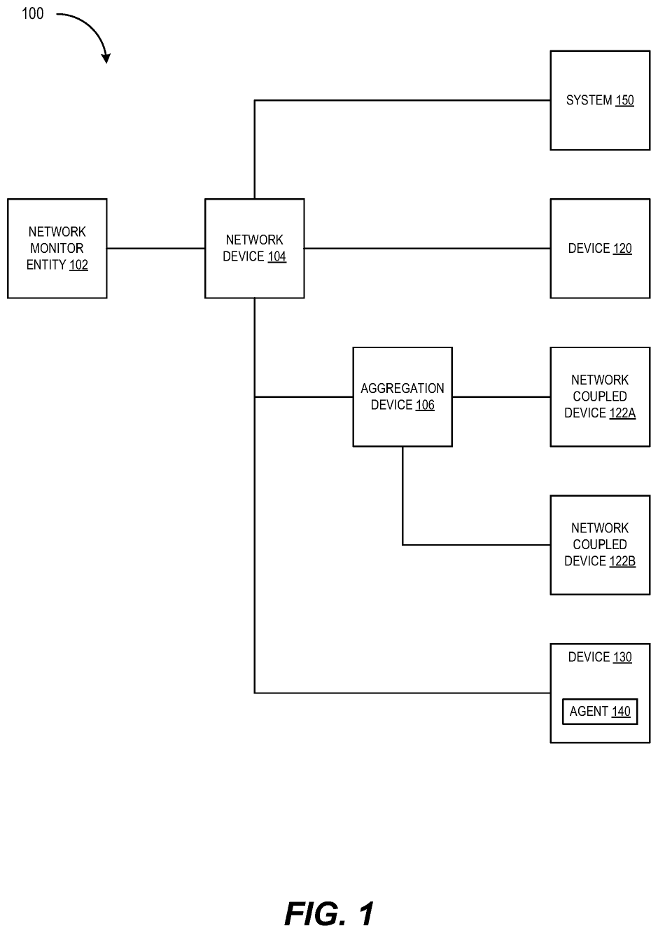

FIG. 1 depicts an illustrative communication network 100, in accordance with one implementation of the present disclosure. The communication network 100 includes a network monitor entity 102, a network device 104, an aggregation device 106, a system 150, devices 120 and 130, and network coupled devices 122A-B. The devices 120 and 130 and network coupled devices 122A-B may be any of a variety of devices including, but not limited to, computing systems, laptops, smartphones, servers, Internet of Things (IoT) or smart devices, supervisory control and data acquisition (SCADA) devices, operational technology (OT) devices, campus devices, data center devices, edge devices, etc. It is noted that the devices/entities of communication network 100 may communicate in a variety of ways including wired and wireless connections and may use one or more of a variety of protocols.

Network device 104 may be one or more network entities configured to facilitate communication among aggregation device 106, system 150, network monitor entity 102, devices 120 and 130, and network coupled devices 122A-B. Network device 104 may be one or more network switches, access points, routers, firewalls, hubs, etc.

Network monitor entity 102 may be operable for a variety of tasks such as classification and device profiling based on raw text of device properties, as described herein. Network monitor entity 102 may be a computing system, network device (e.g., router, firewall, an access point), network access control (NAC) device, intrusion prevention system (IPS), intrusion detection system (IDS), deception device, cloud-based device, virtual machine based system, etc. Network monitor entity 102 may be communicatively coupled to the network device 104 in such a way as to receive network traffic flowing through the network device 104 (e.g., port mirroring, sniffing, acting as a proxy, passive monitoring, a SPAN (Switched Port Analyzer) port, etc.). In some embodiments, network monitor entity 102 may include one or more of the aforementioned devices. In various embodiments, network monitor entity 102 may further support high availability and disaster recovery (e.g., via one or more redundant devices).

Network monitor entity 102 may perform classification of entities of the network 100 using a classification model generated using text-based classification methods. In some examples, the network monitor entity 102 may generate the classification model using aggregated device data and classifications. In other examples, the classification model is generated at a separate system (e.g., system 150) and deployed at the network monitor entity 102 for performing entity classification. In some embodiments, a text-based model generator may process raw text information (e.g., Nmap scan, network traffic logs, device logs from an agent, etc.) to generate a set of character strings associated with properties of multiple monitored entities. The text-based model generator may then apply a natural language processing model to the sets of character strings to generate multi-dimensional vectors, each representing a device embedded in the multi-dimensional vector space. Because devices with similar functionalities will include sets of character strings (also referred to herein as paragraphs) that have a similar structure or context, devices with similar functionalities will be grouped or clustered in the vector space. For example, although the text for device names or identity may be different, devices that perform similar operations may include additional features that are logged or recorded as similar text or “paragraph” structure (e.g., order, number, or type of features included in the text paragraph). Accordingly, entities with similar features will be embedded in the multi-dimensional vector space in a similar manner (e.g., in groups or clusters).

In some embodiments, the text-based model generator may then rank and select the entity features based on the feature relevance for entity classification determined by the embedded groupings of devices in the vector space. For example, the text-based model generator may apply a feature selection model to the groupings to determine how strongly each feature correlates with the groupings. The features may be ranked based on the correlation with the groupings and a subset of entity features are selected based on the rankings (e.g., certain number of highest ranked features are selected). In some embodiments, the text-based model generator may then train a machine learning classifier using the selected features from entities with known classifications to generate an entity classification model. Accordingly, the entity classification model may be deployed to classify entities of the network 100 based on the selected features extracted from network traffic associated with entities of the network. Because the features are extracted based on context in raw log data, the classification model is capable of classification of entities based on entity functionality rather than entity identification.

In some embodiments, network monitor entity 102 may monitor a variety of protocols (e.g., Samba, hypertext transfer protocol (HTTP), secure shell (SSH), file transfer protocol (FTP), transfer control protocol/internet protocol (TCP/IP), user datagram protocol (UDP), Telnet, HTTP over secure sockets layer/transport layer security (SSL/TLS), server message block (SMB), point-to-point protocol (PPP), remote desktop protocol (RDP), windows management instrumentation (WMI), windows remote management (WinRM), etc.).

The monitoring of entities by network monitor entity 102 may be based on a combination of one or more pieces of information including traffic analysis, information from external or remote systems (e.g., system 150), communication (e.g., querying) with an aggregation device (e.g., aggregation device 106), and querying the device itself (e.g., via an API, CLI, web interface, SNMP, etc.), which are described further herein. Network monitor entity 102 may be operable to use one or more APIs to communicate with aggregation device 106, device 120, device 130, or system 150. Network monitor entity 102 may monitor for or scan for entities that are communicatively coupled to a network via a NAT device (e.g., firewall, router, etc.) dynamically, periodically, or a combination thereof.

Information from one or more external or 3^{rd} party systems (e.g., system 150) may further be used for determining one or more tags or characteristics for an entity. For example, a vulnerability assessment (VA) system may be queried to verify or check if an entity is in compliance and provide that information to network monitor entity 102. External or 3^{rd} party systems may also be used to perform a scan or a check on an entity to determine a software version.

Device 130 can include agent 140. The agent 140 may be a hardware component, software component, or some combination thereof configured to gather information associated with device 130 and send that information to network monitor entity 102. The information can include the operating system, version, patch level, firmware version, serial number, vendor (e.g., manufacturer), model, asset tag, software executing on an entity (e.g., anti-virus software, malware detection software, office applications, web browser(s), communication applications, etc.), services that are active or configured on the entity, ports that are open or that the entity is configured to communicate with (e.g., associated with services running on the entity), media access control (MAC) address, processor utilization, unique identifiers, computer name, account access activity, etc. The agent 140 may be configured to provide different levels and pieces of information based on device 130 and the information available to agent 140 from device 130. Agent 140 may be able to store logs of information associated with device 130. Network monitor device 102 may utilize agent information from the agent 140. While network monitor entity 102 may be able to receive information from agent 140, installation or execution of agent 140 on many entities may not be possible, e.g., IoT or smart devices.

System 150 may be one or more external, remote, or third party systems (e.g., separate) from network monitor entity 102 and may have information about devices 120 and 130 and network coupled devices 122A-B. System 150 may include a vulnerability assessment (VA) system, a threat detection (TD) system, endpoint management system, a mobile device management (MDM) system, a firewall (FW) system, a switch system, an access point system, etc. Network monitor entity 102 may be configured to communicate with system 150 to obtain information about devices 120 and 130 and network coupled devices 122A-B on a periodic basis, as described herein. For example, system 150 may be a vulnerability assessment system configured to determine if device 120 has a computer virus or other indicator of compromise (IOC).

The vulnerability assessment (VA) system may be configured to identify, quantify, and prioritize (e.g., rank) the vulnerabilities of an entity. The VA system may be able to catalog assets and capabilities or resources of an entity, assign a quantifiable value (or at least rank order) and importance to the resources, and identify the vulnerabilities or potential threats of each resource. The VA system may provide the aforementioned information for use by network monitor entity 102.

The advanced threat detection (ATD) or threat detection (TD) system may be configured to examine communications that other security controls have allowed to pass. The ATD system may provide information about an entity including, but not limited to, source reputation, executable analysis, and threat-level protocols analysis. The ATD system may thus report if a suspicious file has been downloaded to an entity being monitored by network monitor entity 102.

Endpoint management systems can include anti-virus systems (e.g., servers, cloud based systems, etc.), next-generation antivirus (NGAV) systems, endpoint detection and response (EDR) software or systems (e.g., software that record endpoint-system-level behaviors and events), compliance monitoring software (e.g., checking frequently for compliance).

The mobile device management (MDM) system may be configured for administration of mobile devices, e.g., smartphones, tablet computers, laptops, and desktop computers. The MDM system may provide information about mobile devices managed by MDM system including operating system, applications (e.g., running, present, or both), data, and configuration settings of the mobile devices and activity monitoring. The MDM system may be used get detailed mobile device information which can then be used for device monitoring (e.g., including device communications) by network monitor entity 102.

The firewall (FW) system may be configured to monitor and control incoming and outgoing network traffic (e.g., based on security rules). The FW system may provide information about an entity being monitored including attempts to violate security rules (e.g., unpermitted account access across segments) and network traffic of the entity being monitored.

The switch or access point (AP) system may be any of a variety of network entities (e.g., network device 104 or aggregation device 106) including a network switch or an access point, e.g., a wireless access point, or combination thereof that is configured to provide an entity access to a network. For example, the switch or AP system may provide MAC address information, address resolution protocol (ARP) table information, device naming information, traffic data, etc., to network monitor entity 102 which may be used to monitor entities and control network access of one or more entities. The switch or AP system may have one or more interfaces for communicating with IoT or smart devices or other entities (e.g., ZigBee™, Bluetoot™, etc.), as described herein. The VA system, ATD system, and FW system may thus be accessed to get vulnerabilities, threats, and user information of an entity being monitored in real-time which can then be used to determine a risk level of the entity.

Aggregation device 106 may be configured to communicate with network coupled devices 122A-B and provide network access to network coupled devices 122A-B. Aggregation device 106 may further be configured to provide information (e.g., operating system, device software information, device software versions, device names, application present, running, or both, vulnerabilities, patch level, etc.) to network monitor entity 102 about the network coupled devices 122A-B. Aggregation device 106 may be a wireless access point that is configured to communicate with a wide variety of entities through multiple technology standards or protocols including, but not limited to, Bluetooth™, Wi-Fi™, ZigBee™, Radio-frequency identification (RFID), Light Fidelity (Li-Fi), Z-Wave, Thread, Long Term Evolution (LTE), Wi-Fi™ HaLow, HomePlug, Multimedia over Coax Alliance (MoCA), and Ethernet. For example, aggregation device 106 may be coupled to the network device 104 via an Ethernet connection and coupled to network coupled devices 122A-B via a wireless connection. Aggregation device 106 may be configured to communicate with network coupled devices 122A-B using a standard protocol with proprietary extensions or modifications.

Aggregation device 106 may further provide log information of activity and attributes of network coupled devices 122A-B to network monitor entity 102. It is appreciated that log information may be particularly reliable for stable network environments (e.g., where the types of entities on the network do not change often). The log information may include information of updates of software of network coupled devices 122A-B.

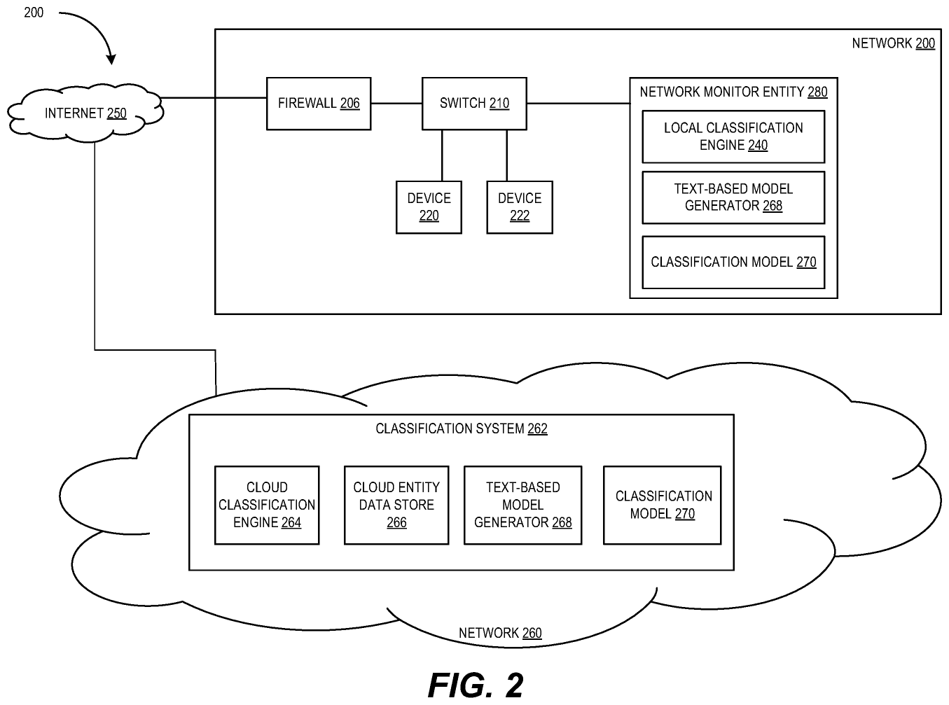

FIG. 2 depicts an illustrative network topology in accordance with one implementation of the present disclosure. FIG. 2 depicts an example network 200 with multiple enforcement points (e.g., firewall 206 and switch 210) and a network monitor entity 280 (e.g., network monitor entity 102) which can perform device profiling and classification using a classification model generated using raw text-based classification, as described herein, associated with the various entities communicatively coupled in example network 200.

FIG. 2 further shows example devices 220-222 (e.g., devices 106, 122A-B, 120, and 130, other physical or virtual devices, other entities, etc.) and it is appreciated that more or fewer network entities or other entities may be used in place of the devices of FIG. 2. Example devices 220-222 may be any of a variety of devices or entities (e.g., smart devices, multimedia devices, networking devices, accessories, mobile devices, IoT devices, retail devices, healthcare devices, etc.), as described herein. Enforcement points including firewall 206 and switch 210 may be any device (e.g., network device 104, cloud infrastructure, etc.) that is operable to allow traffic to pass, drop packets, restrict traffic, etc. Network monitor entity 280 may be any of a variety of network devices or entities, e.g., router, firewall, an access point, network access control (NAC) device, intrusion prevention system (IPS), intrusion detection system (IDS), deception device, cloud-based entity or device, virtual machine based system, etc. Network monitor entity 280 may be substantially similar to network monitor entity 102. Embodiments support IPv4, IPv6, and other addressing schemes. In some embodiments, network monitor entity 280 may be communicatively coupled with firewall 206 and switch 210 through additional individual connections (e.g., to receive or monitor network traffic through firewall 206 and switch 210).

Switch 210 communicatively couples the various entities of network 200 including firewall 206, network monitor entity 280, and devices 220-222. Firewall 206 may perform network address translation (NAT). Firewall 206 communicatively couples network 200 to Internet 250 and firewall 206 may restrict or allow access to Internet 250 based on particular rules or ACLs configured on firewall 206. Firewall 206 and switch 210 are enforcement points, as described herein.

Network monitor entity 280 can access network traffic from network 200 (e.g., via port mirroring or SPAN ports of firewall 206 and switch 210 or other methods). Network monitor entity 280 can perform passive scanning of network traffic by observing and accessing portions of packets from the network traffic of network 200. Network monitor entity 280 may perform an active scan of an entity of network 200 by sending one or more requests to the entity of network 200. The information from passive and active scans of entities of network 200 can be used to determine one or more features associated with the entities of network 200 (e.g., evidence).

Network monitor entity 280 includes local classification engine 240, text-based model generator 268, and classification model 270. Local classification engine 240 may perform classification of the entities of network 200 including firewall 206, switch 210, and devices 220-222. Local classification engine 240 may designate attributes and classify one or more entities of network 200 based on the information collected about, or otherwise associated with the entities. For example, local classification engine 240 may apply the classification model 270 to the extracted entity attributes to classify entities coupled to the network 200. In some embodiments, local classification engine 240 can also send data (e.g., attribute values) about entities of network 200, as determined by local classification engine 240, to classification system 262 of network 260, described in more detail below. Network 260 may be a cloud-based network (e.g., private or public cloud) of interconnected computing devices for providing computing services. Local classification engine 240 may encode and encrypt the data prior to sending the data to classification system 262. Local classification engine 240 may receive a classification from classification system 262 which network monitor entity 280 can use to perform various security related measures. In some embodiments, the network monitor entity 280 may generate the classification model 270 via text-based model generator 268 or receive the classification model 270 from the classification system 262 or from another third-party system. In some embodiments, classification of an entity may be performed in part by local network monitor entity 280 (e.g., local classification engine 240) and in part by classification system 262.

Classification system 262 may be a cloud classification system operable to generate a classification model using text-based classification and to perform device classification, as described herein. In some embodiments, classification system 262 may be part of a larger system operable to perform a variety of functions, e.g., part of a cloud-based network monitor entity, security device, etc. For example, classification system 262 can generate a classification model 270 via a text-based model generator 268 and perform cloud-based classification of devices using the classification model 270. In some examples, cloud classification engine 264 may perform classification of devices of the network 200 (e.g., devices 220-222) using classification model 270. For example, cloud classification engine 264 may classify, or fingerprint, devices by applying the classification model to device profiles (e.g., device properties, features, attributes, characteristics, etc. collected by network monitor entity 280) stored at cloud entity data store 266.

Text-based model generator 268 may receive, retrieve, or otherwise obtain raw device information in text format (e.g., entity log information, Nmap scan data, etc.). The text-based model generator 268 may process the raw device information for each device represented by the information into a set of character strings (also referred to as tokens) that can be processed by a natural language processing model. For example, the raw entity information for each entity may be processed to combine or append information for each property of the device together into a single token and collect the tokens into a paragraph (e.g., each token separated by a space or other delimiting character). The text-based model generator 268 may then apply a natural language processing model on the paragraphs for each device (e.g., as a sentence would be processed for a human readable language). The result of applying the natural language processing model to the feature/property paragraphs may be a numerical vector in a multi-dimensional or high dimensional space. Thus, each entity may be embedded in the high dimensional space and represented by a single numerical vector. Accordingly, the entities may be grouped or clustered in the high dimensional space. The groupings may represent device types with common or similar functionality. In some embodiments, the text-based model generator 268 may select entity features that most correlate with the entity groupings in the high dimensional space. The text-based model generator 268 may then train a machine learning model using as input the selected features from a set of previously classified devices. The resulting trained model may be classification model 270. In some embodiments, the cloud classification engine 264, or the local classification engine 240, may then classify entities coupled to the network 200 by applying the classification model 270 to the entity features extracted by network monitor entity 280.

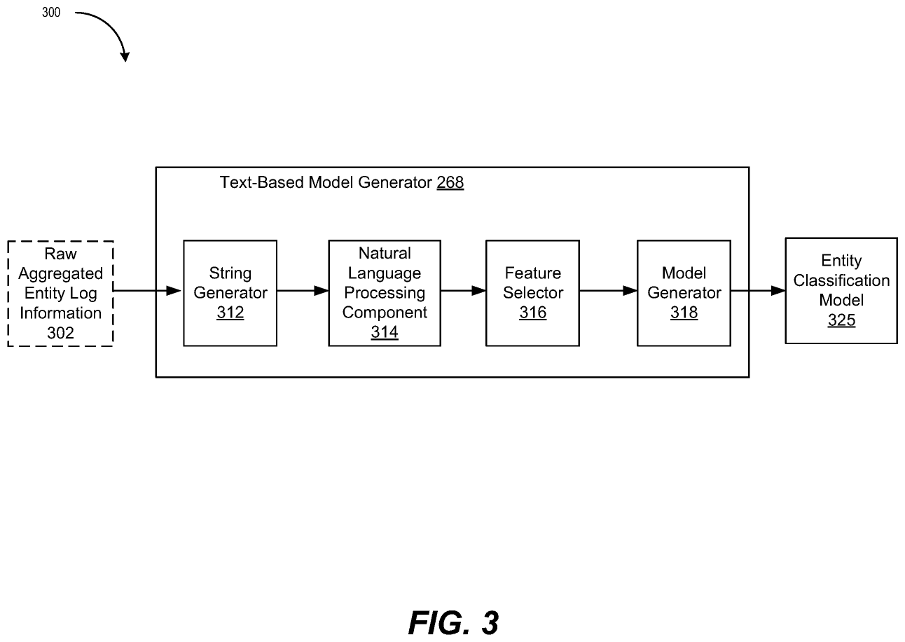

FIG. 3 depicts an example of a system 300 for generating an entity classification model using text classification, according to some embodiments of the present disclosure. System 300 includes a text-based model generator 268, which may be the same or similar to text-based model generator 268 described with respect to FIG. 2. In some embodiments, the text-based model generator 268 may be executed by a processing device of a computing system. As depicted, the text-based model generator 268 may include a string generator 312, natural language processing 314, feature selector 316, and a model generator 318. In some examples, the text-based model generator 268 may include additional components or fewer components than depicted.

In some embodiments, the text-based model generator 268 may obtain raw aggregated entity log information (e.g., any information collected via active or passive network monitoring) to generate an entity classification model 325. The string generator 312 of the text-based model generator 268 may receive the raw aggregated entity log information 302 and convert it into a format that is ingestible by a natural language processing model. For example, the raw aggregated entity log information 302 may include session metadata, such as source IP, destination IP, protocol, payload size, timestamp, etc. (e.g., from network monitoring hardware, software, or a combination of such).

In some embodiments, the raw aggregated entity log information 302 may include device properties in a log format including various alphanumeric representations of the device properties. For example, the raw aggregated entity log information 302 can include general data like MAC addresses, open ports, banner and fingerprint scan results, and running processes, as well as more device-specific data, such as Windows services, third-party integration-specific data, (e.g., virtual server data) etc. In some embodiments, the raw aggregated entity log information 302 may be in a format such as: “IPv4-40fad3061350c1d7f027f7d4d0cfcb9bae17750a, 1528050269, sw_port_desc, Switch Device”, “IPv4-40fad3061350c1d7f027f7d4d0cfcb9bae17750a, 1528050269, sw_virtual_interface, false”, “IPv4-40fad3061350c1d7f027f7d4d0cfcb9bae17750a, 1528028222, mac_prefix32, e8b7483 c”, “IPv4-40fad3061350c1d7f027f7d4d0cfcb9bae17750a, 1528048698, nmap_banner5, 22/tcp Cisco SSH 1.25 protocol 2.0” or any other raw log, scan, or information collection format.

The string generator 312 may append together information associated with a property of a device as a single string or token. For example, the example log information above may be converted to “sw_port_desc_Switch_Device”, “sw_virtual_interface_false” “mac_prefix32_e8b7483c”, and “nmap_banner5_22/tcp_Cisco_SSH_1.25_protocol_2.0” or any other appended format (e.g., with spaces, no spaces, or other spacing character or other variations of combining the log information strings into a single string token). The string generator 312 may further collect the strings associated with properties of the device into a paragraph for that device (e.g., a paragraph of property strings for each device represented by the raw aggregated entity log information 302). The string generator 312 may then provide the resulting paragraphs of property strings to natural language processing component 314. The natural language processing component 314 may apply a natural language processing model to the received paragraphs of property strings to generate a numerical vector for each device in a multi-dimensional vector space (e.g., 32, 64, or more dimensions). The resulting vector for each device may represent an overall functionality of the device based on the property strings and the arrangement of the property strings in the paragraphs for each device.

In some embodiments, the feature selector 316 may receive the numerical vectors for each device from the natural language processing component 314 and identify a level of correlation between entity features and groupings of the entity vectors. For example, the feature selector 316 may rank entity features from highest correlation to entity groupings to lowest correlation. High correlation may indicate that the feature is important for device classification. Accordingly, the feature selector 316 may select a subset of the features with the highest correlation to the entity groupings in the multi-dimensional vector space.

The feature selector 316 then provides the selected subset of features to the model generator 318. In some embodiments, the model generator 318 generates fingerprints for entities of the network based on the groupings and the selected features. In some embodiments, the model generator 318 may train a machine learning model with the selected features as inputs to the model. For example, the model generator may train a classifier using labeled training data, such as previously classified devices and the corresponding feature values for each of the features selected for the model. The output of the model generator 318 may be entity classification model 325 which may classify unknown entities based on the selected subset of features.

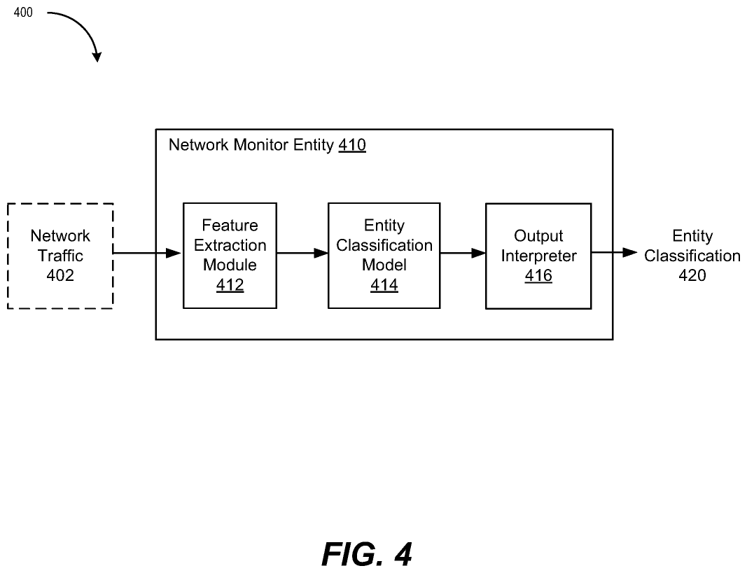

FIG. 4 depicts an example system 400 for performing an entity classification using a classification model generated using text-based classification of raw text information associated with network connected entities, according to embodiments of the present disclosure. As depicted, system 400 includes a network monitor entity 410 that receives network traffic 402 or other device information from a monitored network (e.g., via passive or active scans of the network) and classify entities that are coupled to the network (e.g., upon connection of a new entity to the network). In some embodiments, network monitor entity 410 may be the same or similar to network monitor entity 102 described with respect to FIG. 1 and network monitor entity 280 described with respect to FIG. 2. Network monitor entity 410 may include a feature extraction module 412, an entity classification model 414, and an output interpreter 416. In some embodiments, the feature extraction module 412 may receive network traffic 402 associated with a device coupled to a network and extract one or more features associated with the device from the network traffic. For example, the feature extraction module 412 may parse packets of the network traffic 402 and other information collected about the entity to determine values for one or more features of the entity. For example, the feature extraction module 412 may determine information such as an IP address, MAC address, source and destination addresses, software and firmware versions, communication protocols used, open ports of the entity, or any other determinable features of network connected entities.

The entity classification model 414 may receive the features of an entity extracted by the feature extraction module 412, or a subset of the extracted features, and determine a probability of the entity being one of several potential entity types. In some embodiments, the entity classification model 414 may be the same as entity classification model 325 generated by the text-based model generator 268 of system 300, as described with respect to FIG. 3. Accordingly, the entity classification model 414 may take as input a selected subset of the features extracted by feature extraction module 412 and produce an output probability vector for potential device classifications. In some embodiments, the output interpreter 416 may determine from the output of the entity classification model 414 (e.g., a probability vector) a single classification of the entity and output the entity classification 420. In other embodiments, the output interpreter 416 may determine a “fuzzy” classification. The entity classification 420 may be used to monitor an entity, apply security policies, etc. A “fuzzy” classification may be a resulting classification that is indeterminant, and therefore may suggest a number of possible outcomes with as a set of matching probabilities for each.

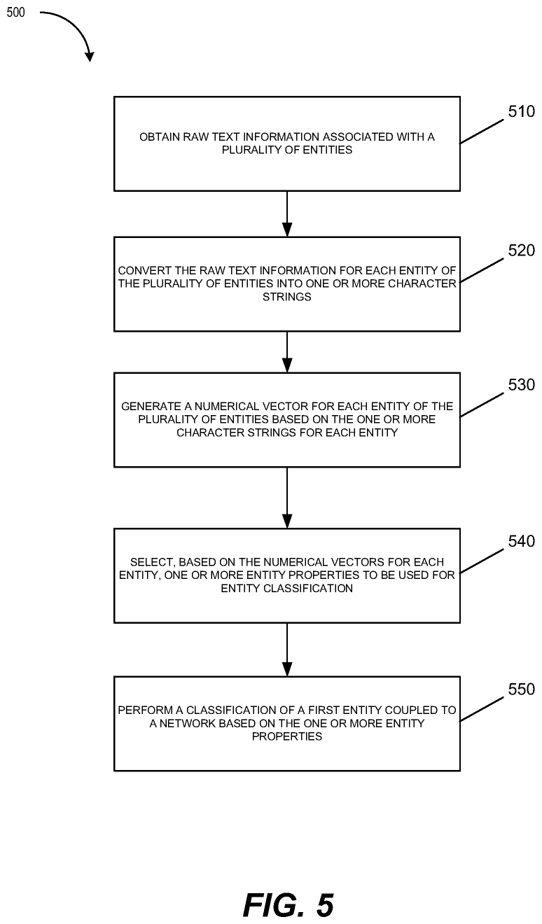

FIG. 5 depicts a flow diagram of aspects of process 500 of generating an entity classification model using text classification in accordance with one implementation of the present disclosure. Various portions of process 500 may be performed by different components (e.g., text-based model generator 268, classification model 270, entity classification model 414, or components of system 800) of an entity or device (e.g., network monitor entity 102, network monitor entity 280, classification system 262, or network monitor entity 410).

Process 500 begins at block 510, where processing logic (e.g., text-based model generator 268) obtains raw text information associated with a plurality of entities. The raw text information may be entity information collected and aggregated from one or more networks (e.g., via network monitoring entities). The raw text information may include Nmap scan information, network traffic logs, device information collected from a local agent, etc. The raw text information may be unprocessed and in a format in which it was originally collected or generated.

At block 520, processing logic (e.g., text-based model generator 268) converts the raw text information for each entity of the plurality of entities into one or more character strings. For example, the raw text information may include information about one or more entity properties that can be used for entity identification and classification. In some examples, the entity properties that are related (e.g., an entity property or label and its corresponding value) may be appended together as a single character string or token. The characters strings may be the basic input unit for a natural language processing model. The strings that are associated with a particular device or entity may be collected into a paragraph of strings.

At block 530, processing logic (e.g., text-based model generator 268) generates a numerical vector for each entity of the plurality of entities based on the one or more character strings for each entity. In some embodiments, the processing logic may apply a natural language processing model to the paragraph of strings for each entity to generate the numerical vectors. Accordingly, each entity can be embedded in a vector space by the natural language processing model.

At block 540, processing logic (e.g., text-based model generator 268) selects one or more entity properties to be used for entity classification based on the numerical vectors generated for each entity of the plurality of entities. In some embodiments, the processing logic may rank potential entity properties based on correlations of each property with the numerical vectors generated for each of the devices. The processing logic may then select a subset of the potential entity properties based on the ranking. For example, the processing logic may select a certain number of the highest-ranking properties (e.g., the top three, top five, or any other number of properties).

At block 550, processing logic (e.g., text-based model generator 268, or network monitor entity 410) performs a classification of a first entity coupled to the network based on the one or more entity properties. In some embodiments, the processing logic may generate a classification model based on the one or more entity properties selected at block 540. For example, the processing logic may train a machine learning classifier on training data including values for the selected entity properties from several previously classified devices. The processing logic may then monitor network traffic associated with an unknown entity coupled to the network (e.g., the first entity) and apply the classification model to classify the unknown entity (e.g., based on the network traffic or other information collected about the device). In some examples, the selected entity properties may be used to generate a fingerprint which the processing logic may use to classify a device. In some embodiments, the classification model may generate a probability vector indicating a likelihood of the first entity being each of a plurality of possible entity classifications or types. The processing logic may select the entity type of the probability vector indicating a highest likelihood for classification of the first entity. In some examples, the classification model may be a logistic regression, random forest classifier, or any other machine learning classifier.

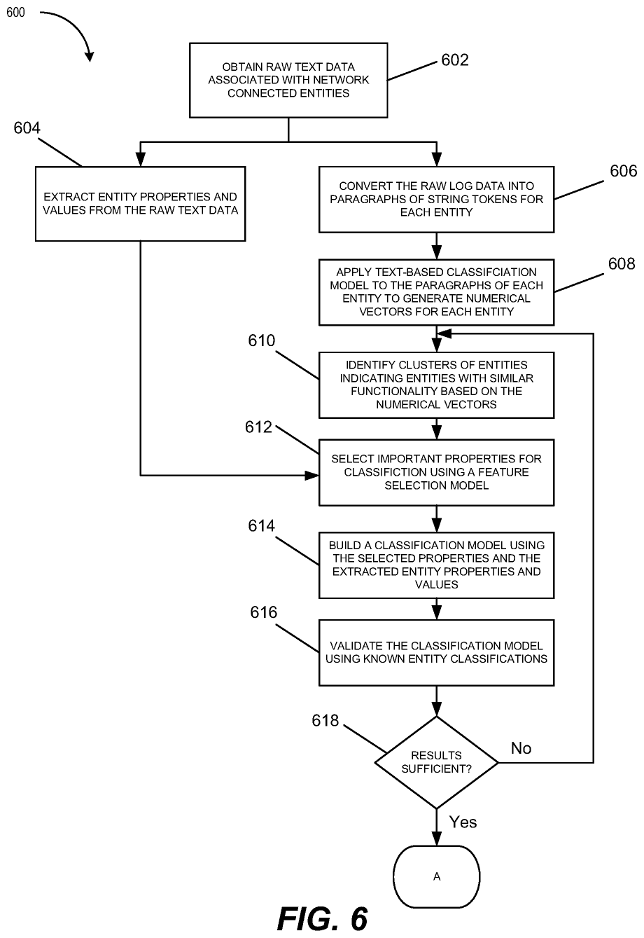

FIG. 6 depicts a flow diagram of aspects of another example process 600 for generating an entity classification model using text classification in accordance with one implementation of the present disclosure. Various portions of process 600 may be performed by different components (e.g., text-based model generator 268, classification model 270, or components of system 800) of an entity or device (e.g., network monitor entity 102, network monitor entity 280, or classification system 262).

Process 600 begins at block 602, where processing logic (e.g., text-based model generator 268) obtains raw text data associated with network connected entities. The raw text data may be in log format (e.g., from Nmap or other device or network scan). At block 604, processing logic (e.g., text-based model generator 268) extracts entity properties and values from the raw text data. For example, the processing logic may identify properties associated with an entity and extract property-value pairs for the identified properties.

At block 606, processing logic (e.g., text-based model generator 268) converts the raw text data into paragraphs of characters strings or tokens for each entity. In some embodiments, the processing logic may stitch together property-value pairs identified from the raw text information into a singular text token or character string. For example, a machine identification may stitch together a machine name, an IP and port together as a single token that can be input into a natural language processing model or other text classification model.

At block 608, processing logic (e.g., text-based model generator 268) applies a text-based classification model (e.g., natural language processing) to the paragraphs of each entity to generate numerical vectors for each entity in a multi-dimensional vector space. For example, the text-based classification model may be a word to vector algorithm that receives sequences of text tokens to generate a numerical vector. In some examples, entities or activity in the log with similar context will be vectorized in a similar manner (e.g., grouped together in the vector space).

At block 610, processing logic (e.g., text-based model generator 268) identifies groupings or clusters of entities indicating entities with similar functionality based on the numerical vectors. At block 612, processing logic (e.g., text-based model generator 268) selects important properties for classification using a feature selection model. In context of properties and values, a feature selection model may include an algorithm (e.g., random forest selection model) to select properties with useful data. For example, printers may leverage one subset of device or entity properties, while devices with a particular operating system may leverage another subset of device or entity properties.

At block 614, processing logic (e.g., text-based model generator 268) builds a classification model using the selected properties and the extracted entity property values. For example, the processing logic may train a machine learning classifier, such as a logistic regression or random forest classifier using values for the selected properties from previously classified entities and the corresponding classifications of the entities.

At block 616, processing logic (e.g., text-based model generator 268) validates the classification model using known entity classifications (e.g., out of pocket data). For example, the results of the classification model may be compared to data sets where the device types are known and thus can determine if the classification model is accurately classifying the devices. In some embodiments, accuracy may be calculated by the percentage of devices for which the computed classifications output from the classification model match the known entity classification.

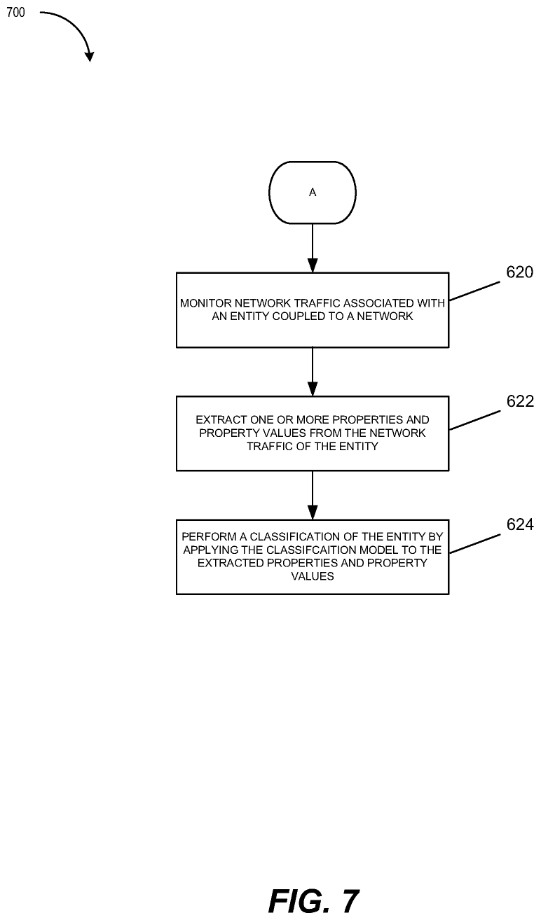

At block 618, processing logic (e.g., text-based model generator 268) determines if the results from validating the model meet a minimum accuracy threshold or other classification criteria. If the classification is sufficient, the process continues to block 620 of process 700 of FIG. 7, otherwise, steps 610 through 616 are repeated with additional or different selection of features and additional or different training data.

FIG. 7 depicts a flow diagram of aspects of process 700 for performing entity classification by an entity classification model generated using text classification in accordance with one implementation of the present disclosure. Various portions of process 700 may be performed by different components (e.g., text-based model generator 268, classification model 270, entity classification model 414, or components of system 800) of an entity or device (e.g., network monitor entity 102, network monitor entity 280, or classification system 262).

Process 700 begins at block 620, where processing logic (e.g., network monitor entity 410 or entity classification model 414) monitors network traffic associated with an entity coupled to a network. In some examples, the processing logic may collect entity information using both passive scanning and active scanning techniques.

At block 622, processing logic (e.g., network monitor entity 410 or entity classification model 414) extracts one or more properties and property values from the network traffic of the entity. At block 624, processing logic (e.g., network monitor entity 410 or entity classification model 414) performs a classification of the entity by applying the classification model generated by process 600 to the extracted properties and property values. The output of the classification model may be a probability vector representing a likelihood that the entity corresponds to different device types. In some embodiments, the processing logic selects a single classification of the device based on the probability vector (e.g., the entity type that has the highest likelihood value). In other embodiments, the processing device provides a fuzzy classification with recommendations for review or confirmation by a user or administrator.

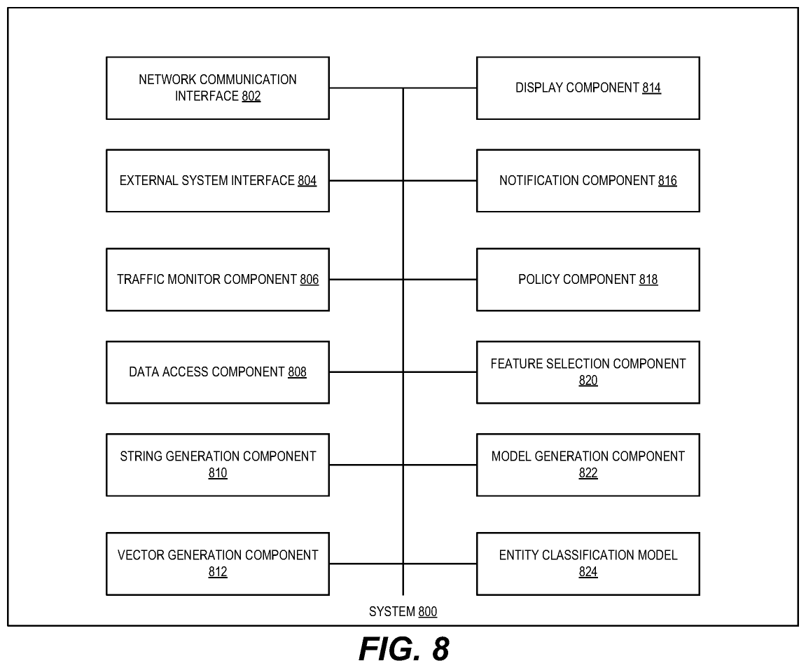

FIG. 8 depicts illustrative components of a system for generating an entity classification model using text classification, in accordance with one implementation of the present disclosure. Example system 800 includes a network communication interface 802, an external system interface 804, a traffic monitor component 806, a data access component 808, a string generation component 810, a vector generation component 812, a display component 814, a notification component 816, a policy component 818, a feature selection component 820, a model generation component 822, and an entity classification model 824. The components of system 800 may be part of a computing system or other electronic device (e.g., network monitor entity 102) or a virtual machine or device and be operable to monitor one or more entities communicatively coupled to a network, monitor network traffic, generate and match attack patterns from cyber threat intelligence, or perform one or more actions (e.g., security action, remediation action, etc.), as described herein. For example, the system 800 may further include a memory and a processing device, operatively coupled to the memory, which may perform the operations of or execute the components of system 800. The components of system 800 may access various data and characteristics or features associated with an entity (e.g., network communication information) and data associated with one or more entities. It is appreciated that the modular nature of system 800 may allow the components to be independent and allow flexibility to enable or disable individual components or to extend, upgrade, or combination thereof components without affecting other components thereby providing scalability and extensibility. System 800 may perform one or more blocks of flow diagrams 500-700. In some embodiments, the components of 800 may be part of network monitor device (e.g., network monitor entities 102), in the cloud, or the various components may be distributed between local and cloud resources.

Communication interface 802 is operable to communicate with one or more entities (e.g., network device 104) coupled to a network that are coupled to system 800 and receive or access information about entities (e.g., device information, device communications, device characteristics, features, etc.), access information as part of a passive scan, send one or more requests as part of an active scan, receive active scan results or responses (e.g., responses to requests), as described herein. The communication interface 802 may be operable to work with one or more components to initiate access to sources of device characteristics for determination of characteristics of an entity to allow determination of one or more features which may then be used for device compliance, asset management, standards compliance, classification, identification, risk assessment or analysis, vulnerability assessment or analysis, etc., as described herein. Communication interface 802 may be used to receive and store network traffic for device classification using a model generated using text-based classification, as described herein.

External system interface 804 is operable to communicate with one or more third party, remote, or external systems to access information including characteristics or features of an entity (e.g., to be used to determine a security aspects) or cyber threat intelligence. External system interface 804 may further store the accessed information in a data store. For example, external system interface 804 may access information from a vulnerability assessment (VA) system to enable determination of one or more compliance or risk characteristics associated with an entity. External system interface 804 may be operable to communicate with a vulnerability assessment (VA) system, an advanced threat detection (ATD) system, a mobile device management (MDM) system, a firewall (FW) system, a switch system, an access point (AP) system, etc. External system interface 804 may query a third-party system using an API or CLI. For example, external system interface 804 may query a firewall or a switch for information (e.g., network session information) about an entity or for a list of entities that are communicatively coupled to the firewall or switch and communications associated therewith. In some embodiments, external system interface 804 may query a switch, a firewall, or other system for information of communications associated with an entity.

Traffic monitor component 806 is operable to monitor network traffic to monitor network traffic associated with entities coupled to a network. Traffic monitor component 806 may have a packet engine operable to access packets of network traffic (e.g., passively) and analyze the network traffic. The traffic monitor component 806 may further be able to access and analyze traffic logs from one or more entities (e.g., network device 104, system 150, or aggregation device 106) or from an entity being monitored. The traffic monitor component 806 may further be able to access traffic analysis data associated with an entity being monitored, e.g., where the traffic analysis is performed by a third-party system.

Data access component 808 may be operable for accessing data including metadata associated with one or more network monitoring entities (e.g., network monitor entities 102), including features that the network monitoring entity is monitoring or collecting, software versions (e.g., of a profile library of the network monitoring entity), and the internal configuration of the network monitoring entity. The data accessed by data access component 808 may be used by embodiments generate a classification model using text-based classification. Data access component 808 may further access vertical or environment data and other user associated data, including vertical, environment, common type of entities for the network or network portions, segments, areas with classification issues, etc., which may be used for classification.

Data access component 808 may access data associated with active or passive traffic analysis or scans or a combination thereof. Information accessed by data access component 808 may be stored, displayed, and used as a basis for generating an entity classification model by applying text-based classification to raw text data from the accessed information, as described herein.

String generation component 810 may receive raw log information (e.g., network traffic log information, device log information, network scan information, etc.) and process the raw log information. The string generation component 810 may convert the raw log information into a series or sequence of strings by combining or appending property information together. For example, the string generation component 810 may combine property-value pairs together into a single string token. The string generation component 810 may also combine the string tokens related to a device or entity into a paragraph of strings (e.g., separated by a space or other delimiting character). Vector generation component 812 may receive the string paragraphs from the string generation component 810 for each device represented by the raw log information and apply a text-based classification model to each paragraph. For example, the vector generation component 812 may apply a natural language processing model to the paragraphs to generate numerical vectors representing each paragraph and thus each entity or device. Groupings of the resulting vectors for each device or entity may indicate similar functionality and thus similar or same entity types.

Feature selection component 820 may identify, based on the resulting vectors and groupings of vectors from vector generation component 812, a set of entity features that most strongly correlate with the groupings of entity vectors. In some embodiments, the features selection component 820 may rank entity features based on a correlation of each feature with the grouping of the entity vectors and select a subset of the features based on the ranking. In some embodiments, the feature selection component 820 may apply a feature selection model to the vectors and vector grouping to identify the most important features for entity classification. Model generation component 822 may train a classification model (e.g., a machine learning classifier) using the selected entity features. In some embodiments, the model generation component 822 may use values for the selected entity features for previously classified or known entities as training data for the classification model. In some embodiments, the model generation component 822 may use features extracted from the raw log information to build, train, and generate a classification model.

Entity classification model 824 may be the resulting model output from the model generation component 822. A network monitor entity may apply the entity classification model 824 to features extracted about a network connected entity from network traffic or active scans of the network and entity or a combination thereof. The entity classification model 824 may receive as input feature values of the entity corresponding to the features selected by features selection component 820. The entity classification model 824 may then produce a classification of entity based on the values of the selected features for the entity. In some embodiments, the entity classification model 824 may generate a probability vector for each entity type as which the entity could be classified. In some embodiments, the entity classification model 824 may output a single classification of the entity (e.g., based on the probability vector). In some embodiments, the entity classification model 824 may output a fuzzy classification.

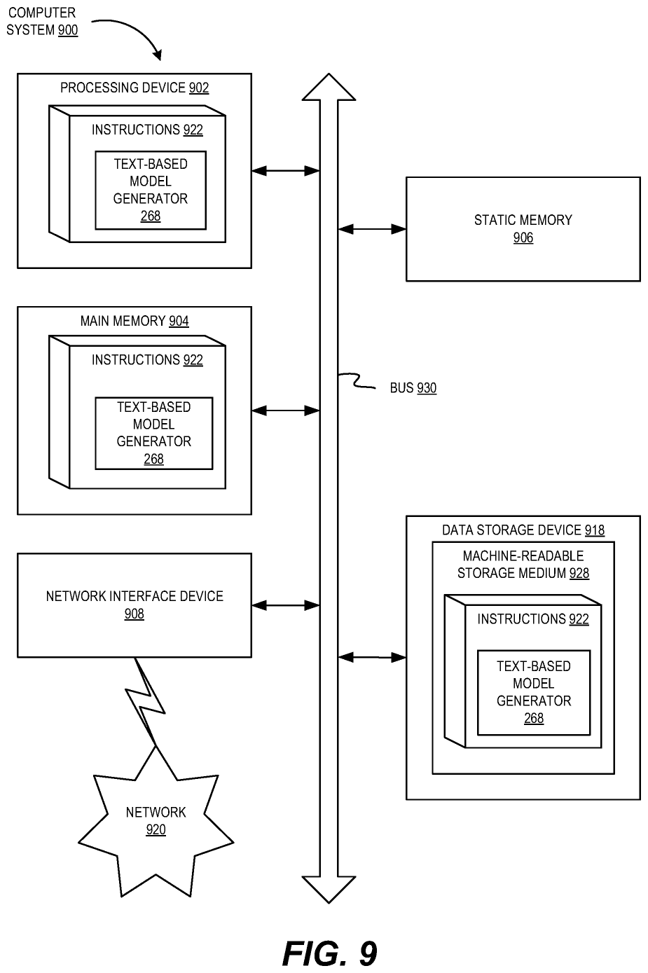

FIG. 9 illustrates a diagrammatic representation of a machine in the example form of a computer system 900 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 900 may be representative of a server, such as network monitor entity 102 running system 800 to generate an entity classification model using text-based classification of raw text information for network connected entities and output a classification of a device or entity.

The exemplary computer system 900 includes a processing device 902, a main memory 904 (e.g., read-only memory (ROM), flash memory, dynamic random access memory (DRAM), a static memory 906 (e.g., flash memory, static random access memory (SRAM), etc.), and a data storage device 918, which communicate with each other via a bus 930. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 922, which may be one example of process 500, 600, or 700 of FIGS. 5-7 or system 800 shown in FIG. 8, for performing the operations and steps discussed herein.

The data storage device 918 may include a machine-readable storage medium 928, on which is stored one or more set of instructions 922 (e.g., software) embodying any one or more of the methodologies of operations described herein, including instructions 922 to cause the processing device 902 to execute a text-based model generator (e.g., text-based model generator 268), perform a classification of a device or entity using a classification model generated based on text classification, or a combination thereof. The instructions 922 may also reside, completely or at least partially, within the main memory 904 or within the processing device 902 during execution thereof by the computer system 900; the main memory 904 and the processing device 902 also constituting machine-readable storage media. The instructions 922 may further be transmitted or received over a network 920 via the network interface device 908.

The machine-readable storage medium 928 may also be used to store instructions to perform a method of device classification model generation using text-based classification of raw text information of devices, as described herein. While the machine-readable storage medium 928 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
obtaining raw text information associated with a plurality of entities;
converting, by a processing device, the raw text information for each entity of the plurality of entities into one or more character strings;
generating, by the processing device, a numerical vector for each entity of the plurality of entities based on the one or more character strings for each entity;
selecting, based on the numerical vectors for each entity of the plurality of entities, one or more entity properties to be used for entity classification; and
performing a classification of a first entity coupled to a network based on the one or more entity properties.

2. The method of claim 1, further comprising:
generating a classification model based on the one or more entity properties.

3. The method of claim 2, wherein performing the classification of the first entity comprises:
monitoring network traffic associated with the first entity coupled to the network; and
performing the classification of the first entity by applying the classification model to the network traffic.

4. The method of claim 3, wherein performing the classification of the first entity further comprises:
generating, by the classification model, a probability vector indicating a likelihood of the first entity being each of a plurality of entity types.

5. The method of claim 4, further comprising:
selecting the entity type of the probability vector indicating a highest likelihood for classification of the first entity.

6. The method of claim 2, wherein the classification model comprises at least one of a logistic regression or a random forest classifier.

7. The method of claim 1, wherein selecting the entity properties comprises:
ranking a plurality of entity properties based on correlations with the numerical vectors of the plurality of entities; and
selecting a subset of the plurality of entity properties based on the ranking.

8. A system comprising:
a memory; and
a processing device, operatively coupled to the memory, to:
obtain raw text information associated with a plurality of entities;
convert the raw text information for each entity of the plurality of entities into one or more character strings;
generate a numerical vector for each entity of the plurality of entities based on the one or more character strings for each entity;
select, based on the numerical vectors for each entity of the plurality of entities, one or more entity properties to be used for entity classification; and
perform a classification of a first entity coupled to a network based on the one or more entity properties.

9. The system of claim 8, wherein the processing device is further to:
generate a classification model based on the one or more entity properties.

10. The system of claim 9, wherein performing the classification of the first entity comprises:
monitor network traffic associated with the first entity coupled to the network; and
perform the classification of the first entity by applying the classification model to the network traffic.

11. The system of claim 10, wherein to perform the classification of the first entity the processing device is to:
generate, by the classification model, a probability vector indicating a likelihood of the first entity being each of a plurality of entity types.

12. The system of claim 11, wherein the processing device is further to:
select the entity type of the probability vector indicating a highest likelihood for classification of the first entity.

13. The system of claim 9, wherein the classification model comprises at least one of a logistic regression or a random forest classifier.

14. The system of claim 8, wherein to select the entity properties the processing device is to:
rank a plurality of entity properties based on correlations with the numerical vectors of the plurality of entities; and
select a subset of the plurality of entity properties based on the ranking.

15. A non-transitory computer readable storage medium including instructions that, when executed by a processing device, cause the processing device to:
obtain raw text information associated with a plurality of entities;
convert, by the processing device, the raw text information for each entity of the plurality of entities into one or more character strings;
generate, by the processing device, a numerical vector for each entity of the plurality of entities based on the one or more character strings for each entity;
select, based on the numerical vectors for each entity of the plurality of entities, one or more entity properties to be used for entity classification; and
perform a classification of a first entity coupled to a network based on the one or more entity properties.

16. The non-transitory computer readable storage medium of claim 15, wherein the processing device is further to:
generate a classification model based on the one or more entity properties.

17. The non-transitory computer readable storage medium of claim 16, wherein performing the classification of the first entity comprises:
monitor network traffic associated with the first entity coupled to the network; and
perform the classification of the first entity by applying the classification model to the network traffic.

18. The non-transitory computer readable storage medium of claim 17, wherein to perform the classification of the first entity the processing device is to:
generate, by the classification model, a probability vector indicating a likelihood of the first entity being each of a plurality of entity types.

19. The non-transitory computer readable storage medium of claim 18, wherein the processing device is further to:
select an entity type of the probability vector indicating a highest likelihood for classification of the first entity.

20. The non-transitory computer readable storage medium of claim 15, wherein to select the entity properties the processing device is to:
rank a plurality of entity properties based on correlations with the numerical vectors of the plurality of entities; and
select a subset of the plurality of entity properties based on the ranking.
